(19) United States
(12) Patent Application Publication
(10) Pub. No.: US 2006/0087663 A1
(43) Pub. Date: Apr. 27, 2006

(54) Font installer for advanced function presentation

(76) Inventors: Jeffery A. Engelman, Mead, CO (US); James M. Herold, Greeley, CO (US); David E. Stone, Longmont, CO (US)

Correspondence Address: DUFT BORNSEN & FISHMAN, LLP, 1526 SPRUCE STREET, SUITE 302, BOULDER, CO, 80302, US

(21) Appl. No.: 10/974,056

(22) Filed: Oct. 26, 2004

(51) Int. Cl. G06K 15/02

(52) U.S. Cl. 358/1.2

(57) ABSTRACT

A method and system for installing a font from a source to a printing system is disclosed. The font has a plurality of names in a plurality of languages. The method and system include using an installer for installing the font from the source to the printing system and for allowing the plurality of names in the plurality of languages to be viewed after installation of the font. The method and system also include providing a graphical user interface for allowing a user to provide input to and receive information from the installer. In one aspect, the graphical user interface may also be used to display the fonts before and/or during installation. In another aspect, the printing system may be compatible with a different platform from the installer and/or the source.

### CROSS-REFERENCE TO RELATED APPLICATIONS

The present invention is related to co-pending U.S. application Ser. No. ______ (BLD920030027US1) entitled “A PRINTING SYSTEM THAT MANAGES FONT RESOURCES USING SYSTEM INDEPENDENT RESOURCE REFERENCES” filed on ______ and assigned to the assignee of the present applications.

### FIELD OF THE INVENTION

The present invention relates to computer system, and more particularly to a method and system for installing fonts.

### BACKGROUND OF THE INVENTION

Conventional font installers are used to install fonts. FIG. 1 depicts a conventional system 10 in which fonts can be installed. The conventional system 10 includes a source 20 having font 22, a conventional system 30 on which the conventional font installer 32 runs, and a conventional printing system 40 having a resource access table (RAT) 42 and installed font 44. The source 20 might include a CD, diskette, hard drive of a system or other mechanism for storing the data. The font 22 includes all font objects and files defining and otherwise used in printing the font 22 are typically stored in the source 20. However, the font is used in printing on a conventional printing system 40. In order to print using the font, the conventional font installer 32 runs on the system 30 and installs the font 22 from the source 20 to the printing system 40. Typically, this includes copying the font, or all of the information relating to the font, from the source 20 to the printing system 40. Thus, as is shown in FIG. 1, the printing system 40 may include an installed font 44. Moreover, many fonts have names in different languages. Consequently, a default name in a default language is selected. Typically, this selection is made automatically based upon the language of the country associated with the system 30 on which the font installer 32 is run. In addition, the RAT 42 on the printing system 40 is updated in order to reflect the new font 44.

Although the conventional font installer 32 functions, one of ordinary skill in the art will readily recognize that conventional font installers 32 are relatively narrowly constructed. For example, most conventional font installers are targeted for a particular operating system and a particular platform of the printing system 40. In addition, conventional font installers automatically select a particular default name based upon settings in the system on which the conventional font installer is run. Once this selection is made, changing the default is difficult. In addition, other operations such as linking of fonts are difficult. For example, in order to link a font in WINDOWS, the registry (which acts as a RAT in the WINDOWS environment) is altered by a user. If users err in altering the registry, the results may be catastrophic. For example, the system may be difficult to reboot.

Accordingly, what is needed is a more flexible, easier to use system for installing fonts. The present invention addresses such a need.

### BRIEF SUMMARY OF THE INVENTION

The present invention provides a method and system for installing a font from a source to a printing system. The font has a plurality of names in a plurality of languages. The method and system comprise using an installer for installing the font from the source to the printing system and for allowing the plurality of names in the plurality of languages to be viewed after installation of the font. The method and system also comprise providing a graphical user interface for allowing a user to provide input to and receive information from the installer. In one aspect, the graphical user interface may also be used to display the fonts before and/or during installation. In another aspect, the printing system may be compatible with a different platform from the installer and/or the source.

According to the method and system disclosed herein, the present invention provides a font installer capable of installing font(s) in a more flexible fashion.

### BRIEF DESCRIPTION OF SEVERAL VIEWS OF THE DRAWINGS

FIG. 1 is a diagram of a conventional system that installs fonts.

FIG. 2 is a diagram depicting one embodiment of a system in accordance with the present invention for installing fonts in a more flexible manner.

FIG. 3 is a high level flow chart depicting one embodiment of a method in accordance with the present invention for installing fonts.

FIG. 4 is a more detailed flow chart depicting one embodiment of a method in accordance with the present invention for installing fonts.

### DETAILED DESCRIPTION OF THE INVENTION

The present invention relates to computer systems. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and system for installing a font from a source to a printing system. The font has a plurality of names in a plurality of languages. The method and system comprise using an installer for installing the font from the source to the printing system and for allowing the plurality of names in the plurality of languages to be viewed and used after installation of the font. The method and system also comprise providing a graphical user interface for allowing a user to provide input to and receive information from the installer. In one aspect, the graphical user interface may also be used to display the fonts before and/or during installation. In another aspect, the printing system may be compatible with a different platform from the installer and/or the source.

The present invention will be described in terms of a font, a particular source of the font and a particular printing system. However, one of ordinary skill in the art will readily recognize that the method and system can be used with other and/or multiple fonts, source(s) and/or printing system(s). Furthermore, the present invention is described in the context of methods having certain steps described in a particular order. However, nothing prevents the use of other and/or additional steps and/or another order of steps that are not inconsistent with the present invention.

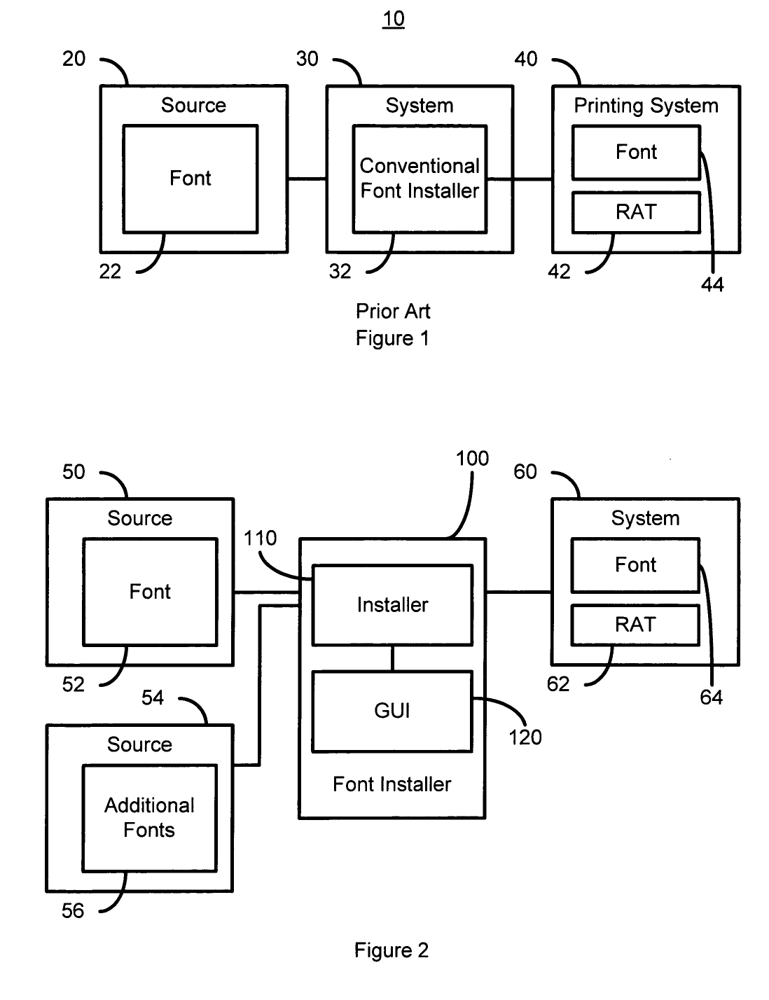

To more particularly describe the method and system in accordance with the present invention, refer to FIG. 2, depicting one embodiment of a system 100 in accordance with the present invention for installing fonts in a more flexible manner. Also shown in FIG. 2 is the source 50 and font 52 to be installed, additional font(s) 56 that may be from other source(s) 54, as well as the system 60 on which the font 52 is installed. The font 52 includes the objects and files (not separately depicted) used in installing and printing using the font 52. Thus, the font 52 is a conventional font analogous to that shown in FIG. 1. Referring back to FIG. 2, the font 52 may have multiple names in multiple languages. Note that only one font 52 and source 50 are depicted, multiple fonts and/or sources could be used. In addition, the font is depicted as being installed. Consequently, the font 64 as well as the RAT 62 are depicted on the system 60. The system 60 is preferably a printing system, such as an AIX system. Furthermore, as used herein, a printing system can be considered to include other computer systems on which a font is desired to be installed. Thus, although the system 60 is preferably a printing system, nothing prevents the system 60 from being another computer system on which installation of the font 52 is desired. For example, the present invention is related to co-pending U.S. application Ser. No. ______(BLD920030027US1) entitled “A PRINTING SYSTEM THAT MANAGES FONT RESOURCES USING SYSTEM INDEPENDENT RESOURCE REFERENCES” filed on ______ and assigned to the assignee of the present applications. Applicant incorporates by reference the above-identified co-pending application. The system 60 is preferably a printing system such as is described in the above-identified co-pending application. A RAT such as the RAT 62 is, therefore, described in more detail in the above-identified co-pending application.

The font installer 100 is run on a computer system (not explicitly shown), such as a WINDOWS computer system. However, nothing prevents the font installer 100 from being run on another system. The font installer 100 includes an installer 110 which may include multiple modules (not separately shown), as well as a graphical user interface (GUI) 120. The installer 110 is used to install the font 52 on the system 60 such that the names of the font in a number of languages can be viewed and used by the user after installation of the font. In a preferred embodiment, the installer 110 also allows the user to view the names in the languages prior to and during installation. In a preferred embodiment, this viewing is accomplished through the GUI 120. Although in a preferred embodiment, the names and languages that are viewable include all of those available for the font 52, in an alternate embodiment, only some subset of the names and languages may be utilized.

In order to install the font 52, the installer 110 stores the font 52 on the system 60, generating the font 62. In addition, the installer 110 updates the RAT 62 to indicate the presence of the font 62. In a system 60 that does not already include a RAT, the installer 110 may generate the RAT to include the appropriate reference(s) to the font 62. Consequently, installation is simplified. Also in a preferred embodiment, the installer 110 is capable of performing these operations for different platforms. Thus, to at least a certain extent, the font installer 100 is platform independent. For example, the system on which the font installer 100 is run may be compatible with a first platform, such as WINDOWS. In contrast, the system 60 may be an AIX or other system. The installer 110 is still capable of installing the font 52 onto the system 60. For example, on a system (not shown) which does not include a RAT, the installer 110 stores the information relating to the font 52 (thereby generating data analogous to the font 62 on the printing system 60) and providing the appropriate references in component(s) analogous to the RAT. In one embodiment, the installer 110 can install the font even though the source 50 and system 60 are physically remote. In a preferred embodiment, this is accomplished using a File transfer protocol (FTP). Thus, the installer 110 may transfer the appropriate files of the font 52 and otherwise communicate with the source 50 and the system 60 using FTP.

When initially installing the font 52, the installer 110 preferably selects a default name based upon the country and language of the system on which the font installer 110 is run. However, in an alternate embodiment, the user might be allowed to select the default initially. In another alternate embodiment, the installer 110 might use other criteria in selecting the default. The installer 110 also preferably allows the default to be changed after installation. In order to do so, the installer 110 preferably displays the other available names and/or languages and allows the user to select a new default using the GUI 120.

The font installer 100 also allows the user to more easily link additional fonts 56. Although the additional fonts 56 are depicted as being from a separate source, nothing prevents the use of multiple sources and/or the same source 50 for the additional fonts. The font installer 100 allows the user to select one or more of the additional fonts 56 to link to the font 52 that is installed. Furthermore, the font installer 100 preferably allows the priorities of the linked fonts to be set. In a preferred embodiment, the font installer 100 allows the priorities of individual characters to be set, allowing replacement and/or modification of the characters in the base font 52 as well as the additional fonts 56. The additional fonts 56 are actually linked and, therefore, installed on the system 60 using the installer 110. Also in a preferred embodiment, the installer 110 can link the additional fonts 56 in a manner similar to the font 52. Thus, the additional fonts 56 may be installed in a manner that is platform independent, allows for the source 54 and system 60 to be physically remote, and viewable in different languages as described above for the font 52.

Moreover, the font installer 110 can preferably generate object identifications (IDs). The installer 110 may thus run an algorithm on the files for the font 52, generate the appropriate object IDs, store these object IDs on the printing system 60, and associate the object IDs with the font 52. The installer 110 may also verify the capabilities of the font 52 and/or system 60 to detect and optionally block undesired uses of a font 52. Moreover, the installer 110 may enforce embedding rules set by the designer of the font 52 and enforce other rules defined by the architecture of the system. For example, in one embodiment, a font that does not include a Unicode map may not be allowed to be installed on the system 60. Thus, the font installer 100 includes a number of additional capabilities.

The installer 110 works in conjunction with the GUI 120. The GUI 120 is used to provide output to and receive input from a user. The GUI 120, therefore, allows the functions of the installer 110 to be viewed, navigated through, and selected in a graphical manner. Thus, in one embodiment, the GUI 120 may provide one or more panes that are used to display information to the user, offer the user a number of choices, and allow the user to enter particular selections. For example, in one embodiment, the GUI 120 lists the name(s) of the font 52 in language(s) in which the font 52 is available on a particular pane. The user may then be allowed to select which name and, therefore, language the installer 110 is to use for the default. This selection might be made by dragging and dropping icons, or through another mechanism. On another pane, accessible to the user through a menu or other graphical mechanism, the GUI 120 allows the user to select the additional fonts 56 to be linked, set priorities, and perform other functions. Furthermore, because the GUI 120 may provide a graphical view of the font, the actual characters in the font may be depicted. This allows a user to better install fonts, including selecting priorities of linked fonts and which characters can or should be replaced.

Thus, the font installer 100 provides a number of benefits. Installation of a font becomes more flexible in a variety of ways. The names in different languages are viewable and the default modifiable, installation of the font becomes simpler and more flexible geographically. For example, a document generated in a first country using a first language and in which the font has a first name may be printable in a second country having a second language in which the font has a second name. The font installer 100 may also not be targeted to specific operating systems or printing system. As a result, the font installer is also more platform independent. Furthermore, font installation is made more flexible because the default name of the font can be more easily modified. Linking of fonts, including individual characters, as well as setting priorities of or modifying linked fonts is also made simpler. Furthermore, the font installer 100 is simpler to utilize, automatically generating object IDs, enforcing embedded rules, and verifying capabilities. Moreover, because of the use of the GUI 120, information is more easily comprehended by the user and the font installer 100 is made simpler to use.

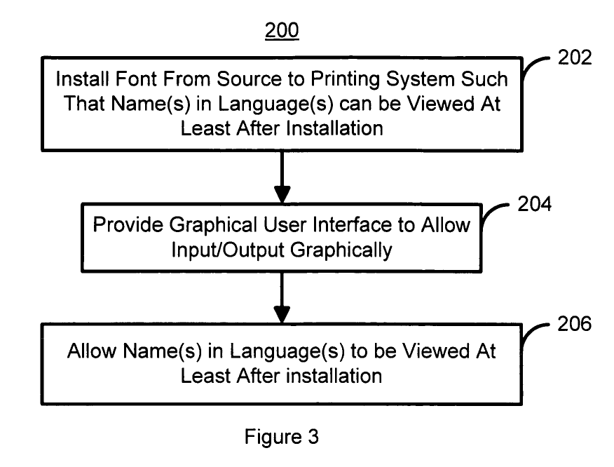

FIG. 3 is a high level flow chart depicting one embodiment of a method 200 in accordance with the present invention for installing fonts. The method 200 preferably uses the font installer 100. Consequently, the method 200 is described in the context of the font installer 100. Referring to FIGS. 2 and 3, information relating to the font 52 is provided from the source 50 to the system 60 using an installer such as the installer 110, via step 202. The information is provided to the system 60 in step 202 in a manner that allows the names of the font in different languages to be viewed and used after the installation has completed. Step 202 also preferably includes automatically selecting a default name and, therefore, language for the font. A user is allowed to provide input to and receive information from the installer 110 using the graphical user interface 120, via step 204. Thus, the user is provided with information in a more readily understandable format. The plurality of names in the plurality of languages to be viewed after installation of the font, via step 206. Thus, the user may make changes to the default and the document may be printed in other languages using other printing systems. Because the method 200 is used the benefits of the font installer 100 may be achieved.

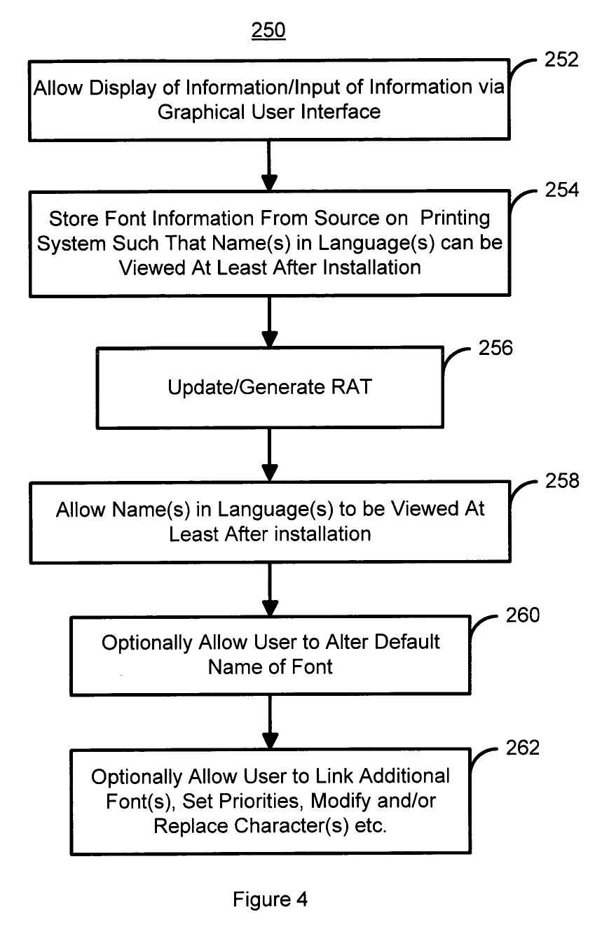

FIG. 4 is a more detailed flow chart depicting one embodiment of a method 250 in accordance with the present invention for installing fonts. The method 250 preferably uses the font installer 100. Consequently, the method 250 is described in the context of the font installer 100.

Referring to FIGS. 2 and 4, the GUI 120 is used to graphically depict information for font installation to the user, via step 252. Step 252 may include depicting the names in different languages to the user. Moreover, step 252 may include depicting a starting pane from which the user can select a variety of functions, such as font installation, font linking, or other activities. The user is also allowed to navigate through the GUI to the desired function(s) in step 252.

Information relating to the font 52 is provided from the source 50 to the system 60 using an installer such as the installer 110, via step 254. Thus, the font 64 is provided on the system 60 through step 254. Step 254 also preferably includes automatically selecting a default name and, therefore, language for the font. However, in another embodiment, the default could be selected using information entered by the user in step 252. Step 262 preferably also includes the generation of any object IDs and associating of the object IDs with the source 50. The RAT 62 is updated or created based on the font being installed, via step 256. Steps 254 and 256 may, therefore, be considered one implementation of step 202 in the method 200 of FIG. 3. Referring back to FIGS. 2 and 4, the plurality of names in the plurality of languages to be viewed after installation of the font, via step 258. Steps 260 and 262 optionally allow the user to access other functions. The user may make changes to the default name, via step 260. Step 260 thus preferably includes displaying the names of the font 52 in different languages to the user and allowing the user to select a new default via the GUI 120. The user is also allowed to link additional font(s) 56, via step 262. Step 262 preferably includes depicting the additional fonts 56, characters in the font 52 and additional fonts 56, allowing the user to select one or more of the additional fonts 56 for linking, and allowing the user to set priorities of the linked fonts 56 and/or individual characters thereof. Furthermore, step 262 is preferably performed using the GUI 120.

Using the method 250, the user can more easily install fonts, change defaults, link other fonts and achieve other objectives related to the fonts. Because these operations are performed in conjunction with information displayed and/or entered using the GUI 120, management of fonts is further facilitated. In a preferred embodiment, therefore, benefits analogous to those described above for the font installer 100 may be achieved.

A method and system for installing font(s) in a more flexible manner has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A system for installing a font from a source to a printing system, the font having a plurality of names in a plurality of languages, the system comprising:
an installer for installing the font from the source to the printing system and for allowing the plurality of names in the plurality of languages to be viewed after installation of the font;
a graphical user interface for allowing a user to provide input to and receive information from the installer.

2. The system of claim 1 wherein the installer further allows a default name of the plurality of names to be selected and subsequently altered.

3. The system of claim 1 wherein the installer is compatible with a first platform and wherein the printing system is compatible with a second platform.

4. The system of claim 3 wherein the first platform and the second platform are the same.

5. The system of claim 4 wherein the first platform and the second platform are different.

6. The system of claim 1 wherein the installer further allows at least one additional font to be linked to the font.

7. The system of claim 6 wherein the at least one additional font has a first plurality of names in a first plurality of languages, and wherein the installer links the at least one additional font such that the first plurality of names is viewable after linking of the at least one additional font.

8. The system of claim 6 wherein the installer further allows at least one priority to be provided for the at least one additional font and the font.

9. The system of claim 6 wherein the installer further allows at least one priority to be provided for at least a portion of a plurality of characters for the at least one additional font and the font.

10. The system of claim 6 wherein the installer further allows at least a portion of the at least one additional font to replace a portion of the font.

11. The system of claim 1 wherein the installer installs the font by storing at least one font object corresponding to the font on the printing system and providing a reference to the font in a resource access table (RAT) of the printing system.

12. The system of claim 1 wherein the source is at a first location and the printing system is at a second location.

13. The system of claim 12 wherein the installer uses a file transfer protocol (FTP) to install the font on the printing system.

14. The system of claim 1 wherein the installer further generate an object identification for each font object of the font.

15. The system of claim 14 wherein the installer associates the object identification with the font.

16. The system of claim 1 wherein the installer further displays the plurality of names in the plurality of languages on the graphical user interface before and/or during installation of the font.

17. A method for installing a font from a source to a printing system, the font having a plurality of names in a plurality of languages, the method comprising:
providing information relating to the font from the source to the printing system using an installer;
allowing a user to provide input to and receive information from the installer using a graphical user interface; and
allowing the plurality of names in the plurality of languages to be viewed after installation of the font.

18. The method of claim 17 wherein further comprising:
allowing a default name of the plurality of names to be selected and subsequently altered.

19. The method of claim 17 wherein the installer is compatible with a first platform and wherein the printing system is compatible with a second platform.

20. The method of claim 19 wherein the first platform and the second platform are the same.

21. The method of claim 20 wherein the first platform and the second platform are different.

22. The method of claim 17 further comprising:
allowing at least one additional font to be linked to the font.

23. The method of claim 22 wherein the at least one additional font has a first plurality of names in a first plurality of languages, and wherein the at least one additional font allowing step further includes:
linking the at least one additional font such that the first plurality of names is viewable after linking of the at least one additional font.

24. The method of claim 22 wherein the linking further includes:
allowing at least one priority to be provided for the at least one additional font and the font.

25. The method of claim 22 wherein the linking further includes:
allowing at least one priority to be provided for at least a portion of a plurality of characters for the at least one additional font and the font.

26. The method of claim 22 wherein the linking further includes replacing a portion of the font with at least a portion of the at least one additional font.

27. The method of claim 17 wherein the information providing further includes:
storing at least one font object corresponding to the font on the printing system; and
providing a reference to the font in a resource access table (RAT) of the printing system.

28. The method of claim 17 wherein the source is at a first location and the printing system is at a second location.

29. The method of claim 17 wherein the information providing further includes:
using a file transfer protocol (FTP) to provide the information to the printing system.

30. The method of claim 17 further comprising:
generating an object identification for each font object of the font.

31. The method of claim 30 further comprising:
associating the object identification with the source.

32. The method of claim 17 further comprising displaying the plurality of names in the plurality of languages on the graphical user interface before and/or during installation of the font.
